(19) United States
(12) Patent Application Publication
(10) Pub. No.: US 2017/0279866 A1
(43) Pub. Date: Sep. 28, 2017

(54) ADAPTATION OF STREAMING DATA BASED ON THE ENVIRONMENT AT A RECEIVER

(71) Applicant: Intel Corporation, Santa Clara, CA (US)

(72) Inventors: Patrice Bertrand, Tournefeuille (FR); Christophe Comps, Cugnaux (FR); Laurent Lancerica, Toulouse (FR)

(73) Assignee: Intel Corporation, Santa Clara, CA (US)

(21) Appl. No.: 15/076,944

(22) Filed: Mar. 22, 2016

(51) Int. Cl. H04L 29/06

(52) U.S. Cl. CPC H04L 65/601; H04L 65/4069

(57) ABSTRACT

An apparatus is described herein. The apparatus includes an environmental conditions capture mechanism, a controller, and a receiver. The environmental conditions capture mechanism is to obtain environmental information. The controller is to control streaming data based on the environmental information. The receiver is to receive streaming data that is adapted based on the environmental information and a volume of the streaming data is reduced as a result of adapting the streaming data.

### BACKGROUND ART

Audio, video, text, and images are often streamed to mobile devices. These devices may render the streamed content locally or on a remote display. The rendered content may be sent to multiple devices at various locations from a single content provider.

### BRIEF DESCRIPTION OF THE DRAWINGS

FIG. 1 is a block diagram of an exemplary system that enables remote adaptation of streaming data based on the environment at a receiver;

FIG. 2 is a process flow diagram describing a color compensation method;

FIG. 3 is an illustration of a system that enables remote adaptation of live streaming data based on the environment at a receiver;

FIG. 4 is an illustration of a system that enables remote adaptation of pre-recorded streaming data based on the environment at a receiver;

FIG. 5 is a process flow diagram of a method for remote adaptation of streaming data based on the environment at a receiver; and

FIG. 6 is a block diagram showing media that contains logic for user input based environmental condition capture.

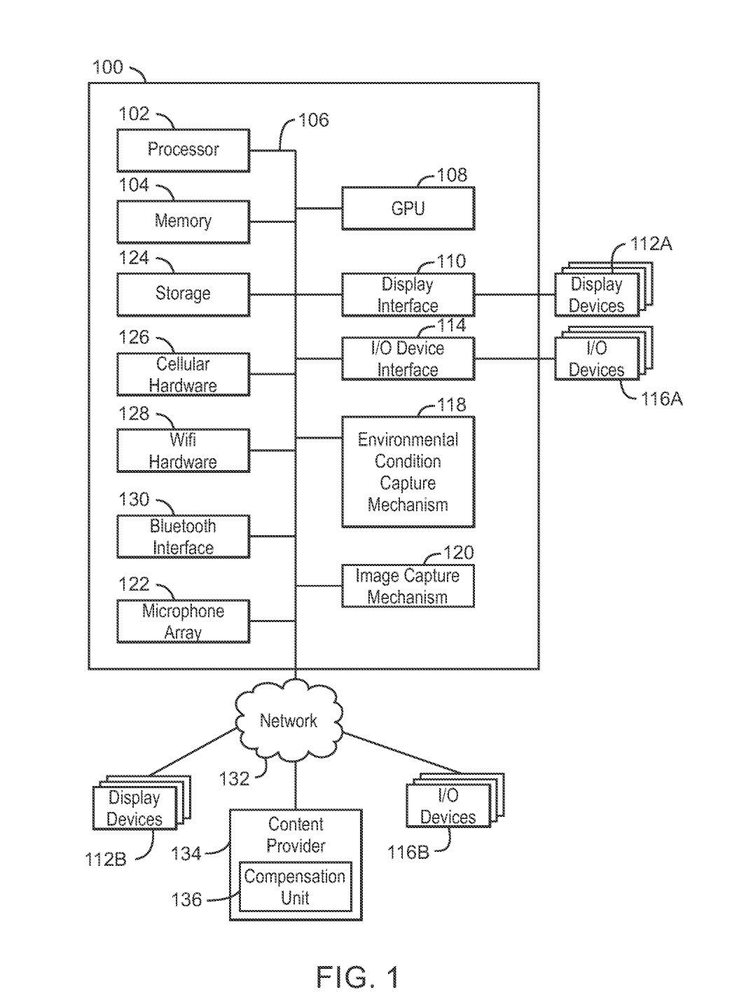

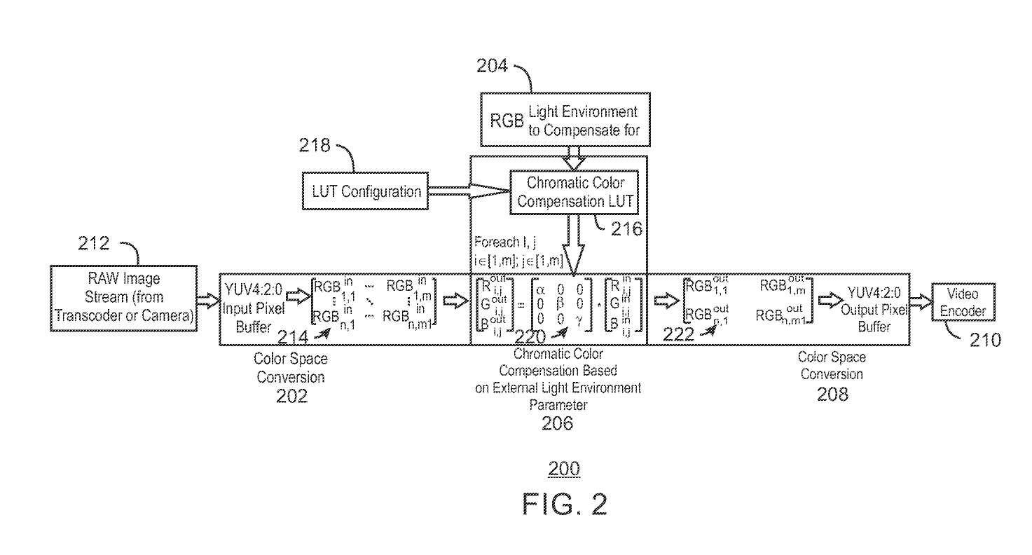

The same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

Streaming media includes various content forms that are delivered by a content provider, received by a device, and presented to a user. The device enables users to connect to a network, such as the Internet, and stream music, movies, television programming, images, and other media. In embodiments, streaming indicates that the content forms are continually delivered by the content provider, and the content forms are received by the device and presented to a user while being continually delivered by the content provider. While streaming continually delivers content to a device, streaming is distinguished from downloading where the data is transferred and stored for later use. As used herein, “stored for later” use may refer to storage other than the temporary storage that may occur with streaming, such as buffering, placing streaming data in a queue, and the like.

In embodiments, streaming video data includes content such as images, text, video, audio, and animations associated with a streaming video session. Streaming video data may also include live streaming data, where live content is delivered a network. A live stream, as used herein, refers to content that is captured in real time and subsequently streamed to a device as the content is continually captured at a source. Regardless of the type of streaming data, the streaming data is typically rendered without regard to environmental conditions. In some cases, the rendered data is of poor quality in view of the environmental conditions where the device that renders the data is located. Embodiments described herein enable remote adaptation of streaming data based on the environment at the receiver. In embodiments, the present techniques enable remote chromatic color adaptation of streaming video based on environmental light at the receiver.

Some embodiments may be implemented in one or a combination of hardware, firmware, and software. Further, some embodiments may also be implemented as instructions stored on a machine-readable medium, which may be read and executed by a computing platform to perform the operations described herein. A machine-readable medium may include any mechanism for storing or transmitting information in a form readable by a machine, e.g., a computer. For example, a machine-readable medium may include read only memory (ROM); random access memory (RAM); magnetic disk storage media; optical storage media; flash memory devices; or electrical, optical, acoustical or other form of propagated signals, e.g., carrier waves, infrared signals, digital signals, or the interfaces that transmit and/or receive signals, among others.

An embodiment is an implementation or example. Reference in the specification to “an embodiment,” “one embodiment,” “some embodiments,” “various embodiments,” or “other embodiments” means that a particular feature, structure, or characteristic described in connection with the embodiments is included in at least some embodiments, but not necessarily all embodiments, of the present techniques. The various appearances of “an embodiment,” “one embodiment,” or “some embodiments” are not necessarily all referring to the same embodiments. Elements or aspects from an embodiment can be combined with elements or aspects of another embodiment.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

FIG. 1 is a block diagram of an exemplary system that enables remote adaptation of streaming data based on the environment at a receiver. The electronic device 100 may be, for example, a laptop computer, tablet computer, mobile phone, smart phone, or a wearable device, among others. The electronic device 100 may be used to receive streaming data, and may be referred to as a receiver. The electronic device 100 may include a central processing unit (CPU) 102 that is configured to execute stored instructions, as well as a memory device 104 that stores instructions that are executable by the CPU 102. The CPU may be coupled to the memory device 104 by a bus 106. Additionally, the CPU 102 can be a single core processor, a multi-core processor, a computing cluster, or any number of other configurations. Furthermore, the electronic device 100 may include more than one CPU 102. The memory device 104 can include random access memory (RAM), read only memory (ROM), flash memory, or any other suitable memory systems. For example, the memory device 104 may include dynamic random access memory (DRAM).

The electronic device 100 also includes a graphics processing unit (GPU) 108. As shown, the CPU 102 can be coupled through the bus 106 to the GPU 108. The GPU 108 can be configured to perform any number of graphics operations within the electronic device 100. For example, the GPU 108 can be configured to render or manipulate graphics images, graphics frames, videos, streaming data, or the like, to be rendered or displayed to a user of the electronic device 100. In some embodiments, the GPU 108 includes a number of graphics engines, wherein each graphics engine is configured to perform specific graphics tasks, or to execute specific types of workloads.

The CPU 102 can be linked through the bus 106 to a display interface 110 configured to connect the electronic device 100 to one or more display devices 112A. The display devices 112 can include a display screen that is a built-in component of the electronic device 100. In embodiments, the display interface 110 is coupled with the display devices 112B via any networking technology such as cellular hardware 124, Wifi hardware 126, or Bluetooth Interface 128 across the network 132. The display devices 112B can also include a computer monitor, television, or projector, among others, that is externally connected to the electronic device 100.

The CPU 102 can also be connected through the bus 106 to an input/output (I/O) device interface 114 configured to connect the electronic device 100 to one or more I/O devices 116A. The I/O devices 116A can include, for example, a keyboard and a pointing device, wherein the pointing device can include a touchpad or a touchscreen, among others. The I/O devices 116A can be built-in components of the electronic device 100, or can be devices that are externally connected to the electronic device 100. Accordingly, in embodiments, the I/O device interface 114 is coupled with the I/O devices 116B via any networking technology such as cellular hardware 124, Wifi hardware 126, or Bluetooth Interface 128 across the network 132. The I/O devices 116B can also include any I/O device that is externally connected to the electronic device 100.

The electronic device 100 also includes an environmental condition capture unit 118. The environmental condition capture unit 118 is to capture data describing the environmental conditions surrounding the electronic device 100. The environmental capture unit 118 may include, for example, a plurality of sensors that are used to obtain environmental conditions. The sensors may include, a light sensor, a temperature sensor, a humidity sensor, a motion sensor, and the like.

In addition to sensors, an image capture device 120 may be used to obtain environmental information. The image capture device may be a camera or an image sensor. Images captured by the image capture device 120 can be analyzed to determine environmental conditions, such as lighting and color temperatures of the surrounding space. A microphone array 122 may be used to capture audio environmental information.

The storage device 124 is a physical memory such as a hard drive, an optical drive, a flash drive, an array of drives, or any combinations thereof. The storage device 124 can store user data, such as audio files, video files, audio/video files, and picture files, among others. The storage device 124 can also store programming code such as device drivers, software applications, operating systems, and the like. The programming code stored to the storage device 124 may be executed by the CPU 102, GPU 108, or any other processors that may be included in the electronic device 100.

The CPU 102 may be linked through the bus 106 to cellular hardware 126. The cellular hardware 126 may be any cellular technology, for example, the 4G standard (International Mobile Telecommunications-Advanced (IMT-Advanced) Standard promulgated by the International Telecommunications Union-Radio communication Sector (ITU-R)). In this manner, the electronic device 100 may access any network 132 without being tethered or paired to another device, where the cellular hardware 126 enables access to the network 132.

The CPU 102 may also be linked through the bus 106 to WiFi hardware 128. The WiFi hardware 128 is hardware according to WiFi standards (standards promulgated as Institute of Electrical and Electronics Engineers' (IEEE) 802.11 standards). The WiFi hardware 128 enables the electronic device 100 to connect to the Internet using the Transmission Control Protocol and the Internet Protocol (TCP/IP). Accordingly, the electronic device 100 can enable end-to-end connectivity with the Internet by addressing, routing, transmitting, and receiving data according to the TCP/IP protocol without the use of another device. Additionally, a Bluetooth Interface 130 may be coupled to the CPU 102 through the bus 106. The Bluetooth Interface 130 is an interface according to Bluetooth networks (based on the Bluetooth standard promulgated by the Bluetooth Special Interest Group). The Bluetooth Interface 130 enables the electronic device 100 to be paired with other Bluetooth enabled devices through a personal area network (PAN). Accordingly, the network 132 may be a PAN. Examples of Bluetooth enabled devices include a laptop computer, desktop computer, ultrabook, tablet computer, mobile device, or server, among others.

The network 132 may be used to obtain streaming data from a content provider 134. The content provider 134 may be any source that provides streaming data to the electronic device 100. The content provider 134 may be cloud based, and may include a server. Users of a mobile device, such as the electronic device 100, stream content to their respective mobile device that originates at the content provider 134. Frequently, users watch streaming data in extreme environments, whether the environments is indoors or outdoors. To facilitate rendering streaming data in any environment, the content provider 134 includes a compensation unit 136 that is to adjust various parameters of the streaming data based on the environmental information captured by the environmental condition capture mechanism of an electronic device 100 that is to receive streaming data. In this manner, streaming video content providers such as the content provider 134 (either video-on-demand (VOD) or user generated-content (UGC) or Multimedia Broadcast Multicast Service (eMBMS) content providers) do not serve the same video stream to all end-users, and the particular video stream is dependent upon the environment in which the end users are located.

In this manner, the chromatic content of served video renders appropriately to the eyes of an end-user watching streaming video outdoors under a bright sun, or to an end-user watching streaming video indoors under a blue-ish LED light. Without this chromatic compensation, overall colors rendered on a display in extreme light environments may look washed out, and end-user experience may be far from optimal. Additionally, the user may tend to not view streaming content without chromatic compensation from the content provider since the streaming content renders poorly in view of the environment of the user.

The block diagram of FIG. 1 is not intended to indicate that the electronic device 100 is to include all of the components shown in FIG. 1. Rather, the computing system 100 can include fewer or additional components not illustrated in FIG. 1 (e.g., sensors, power management integrated circuits, additional network interfaces, etc.). The electronic device 100 may include any number of additional components not shown in FIG. 1, depending on the details of the specific implementation. Furthermore, any of the functionalities of the CPU 102 may be partially, or entirely, implemented in hardware and/or in a processor. For example, the functionality may be implemented with an application specific integrated circuit, in logic implemented in a processor, in logic implemented in a specialized graphics processing unit, or in any other device.

In embodiments, light environment information captured at device/receiver location is used to control color chromaticity of video content streamed by a remote VOD/UGC/eMBMS server. The mobile device/receiver may capture local environment light, at location where video streaming services will be watched. The mobile device/receiver then shares captured local environment light with a remote VOD/UGC/eMBMS service provider. The network hosted VOD/UGC/eMBMS service provider then uses the environment light information sent by the device and improves end-user video playback experience on its local device/receiver by sending chromatic color compensated VOD/UGC/eMBMS streaming videos to the local device/receiver. The information about end-user light environment may be used to either generate on the fly chromatic compensated streaming videos (in case of retransmission of live events over VOD or eMBMS), or to select the best streaming video (or video segment) out of a library of chromatic compensated streaming videos stored at the content provider.

FIG. 2 is a process flow diagram describing a color compensation method 200. The color compensation method may be performed by a compensation unit 136 (FIG. 1). In embodiments, the color compensation method 200 is a cloud hosted color compensation that is applied to a stream of data. The data may be stored in the cloud, or the data may originate at a remote device. For ease of description, the present techniques are described using a red, blue, and green (RGB) color space. However, any color space may be used. Generally, a color space conversion occurs at 202 resulting in RGB data. Environmental information 204 is applied to the RBG data for a color compensation at block 206. At block 208, a second color space conversion is performed to prepare the data for encoding and streaming. At block 210, the data is encoded.

In particular, at block 212, input data is input to the color compensation unit. The input data may be an image stream captured by a camera in case of a live event, or resulting from the playback of a movie. At block 202, the RGB input data may be chroma subsampled by implementing less resolution for the chroma information than for luma information. This subsampling may be performed via a YUV family of color spaces, where the Y component determines the brightness of the color, referred to as luminance or luma. The U and V components determine the color itself, which is the chroma. For example, U may represent the blue-difference chroma component, and V may represent the red-difference chroma component. In embodiments, the chroma subsampling is a YUV4:2:0 subsampling ratio. The YUV family of color spaces describes how RGB information is encoded and decoded, and the sampling ratio describes how the data will be decoded by implementing less resolution for chroma information than for luma information, taking advantage of the human visual system's lower acuity for color differences than for luminance. The subsampled data may be placed in an RGB pixel buffer. A matrix 214 illustrates the pixel data after subsampling at the color space conversion 202.

At block 206, a chromatic color compensation is performed based on an external light environment parameter. The external light environment parameter may be obtained from the environmental information 204. In particular, the environmental information 204 may be used in conjunction with a chromatic color compensation look up table (LUT) 216. The chromatic color compensation LUT 216 may be used to convert a range of input data into another range of parameters to be applied to streaming data. The LUT may be configured as indicated at block 218 by determining the best compensation parameters based on the environmental information. In embodiments, the compensation parameters are to cancel any undesirable rendering parameters in favor of parameters that will render properly such that a user in a particular environment can view the video. The chromatic color compensation LUT 216 can then store those parameters to be applied when the environmental conditions match those in the chromatic color compensation LUT 216. In embodiments, the parameters are stored as a color compensation matrix.

For example, for each RGBin pixel in the image, a new RGBout pixel value is computed, using a chromatic color compensation matrix 220. The resulting compensated data is a function of the RGBin matrix 214, such that the RGBout matrix 222 is RGBout=(Rout, Gout, Bout) with Rout=f(Rin, Gin, Bin), Gout=f(Rin, Gin, Bin), Bout=f(Rin, Gin, Bin), where f is the compensation matrix 220 capturing RGB light environment information, and RGBin is the pixel data where the compensation will be applied. In embodiments, the color compensation matrix 220 contains a light environment value measured at the receiver by an RGB sensor or a camera.

In the color space conversion 208, the RGBout matrix 222 may be encoded using a chroma subsampling ratio of YUV 4:2:0. As discussed above, the chroma sampling ratio describes how the data will be decoded by implementing less resolution for chroma information than for luma information, taking advantage of the human visual system's lower acuity for color differences than for luminance. In embodiments, encoding the adapted video according to a chroma subsampling ratio enables a video stream that can be compressed in the same manner as the original, non-adapted video. Moreover, the present techniques do not increase the size of the adapted video, as typical encoding includes chroma subsampling that implements less resolution for chroma information than for luma information. In adapting the streaming data, the chroma information may be adapted according to the present techniques. The new RGBout pixel buffer that has been chroma subsampled at a ratio of YUV 4:2:0 is sent to the video encoder 210 for further processing and encoding for transmission. In embodiments, a video encoder 210 is a “genuine” video encoder that takes as an input a YUV420 (typically) video stream, and outputs a compressed bitstream.

The color compensation as described above can be applied to both live streaming data as well as to pre-encoded streaming data. In embodiments, to improve overall end user experience when streaming video to a device in varying lighting environments, the cloud server can use the color chromatic processing chain in at least two different ways for use with each of live streaming data and pre-encoded streaming data. In particular, the cloud server may either select a video stream with colors previously adapted for transmission or the cloud server can convert the colors in a live video stream for transmission.

The transmission of an already encoded video stream with colors previously adapted to the chromatic condition at the receiver or a color converted live stream results in an overall reduction in the volume of information that is transmitted to the receiver when compared to sending a non-color compensated stream to the receiver. The reduction in the volume of information is a result of sending only the relevant chromatic content to the receiver in the color compensated video. Relevant chromatic content is chromatic data that has been color compensated, and may also include the associate luma information. Chromatic content that is visible by an end-user eye under the current ambient light gets sent to the device instead of an entire range of chromatic content that is traditionally sent to the receiver. As such, the amount of information to encode by the video encoder at server side is reduced when compared to the amount of information that would have to be encoded without chromatic pre-filtering as described herein.

For example, if the receiver is in a red-ish environment, the server would broadcast a stream with reduced red content. Artificially boosted green and blue colors may be used to compensate for the red-ish environment at the receiver. This change in chroma values can result in less data overall that is transmitted to the receiver. In another example, a live stream is color converted prior to being encoded in order to reduce amount of red content by artificially boosting all non-red colors as in the prior example. The blue and green boosted YUV 4:2:0 color stream is sent to the encoder that will encode it and stream it to the receiver. In this manner, the receiver will receive a stream with less red and more blue and green content. When displayed in a red-ish environment, the viewing experience will be enhanced as the overall video content will not look washed out, as would be the case if the blue and green content had not been boosted.

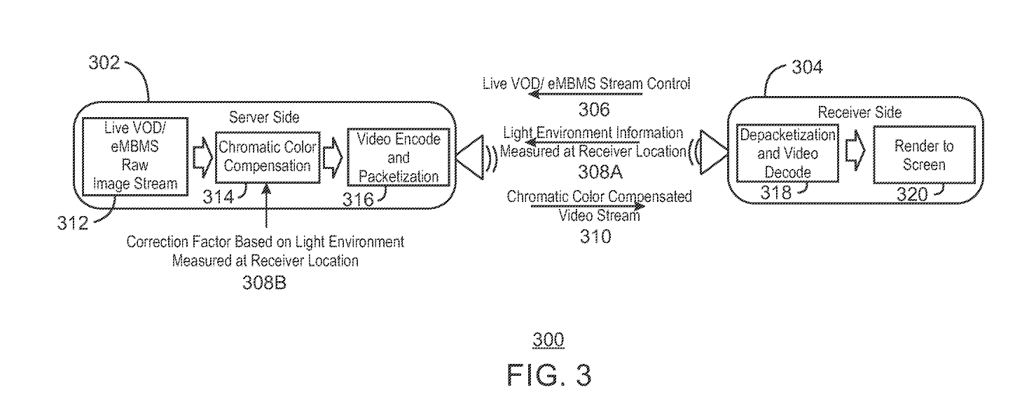

FIG. 3 is an illustration of a system 300 that enables remote adaptation of live streaming data based on the environment at a receiver. A server 302 may be a content provider 134 (FIG. 1). A receiver 302 may be an electronic device 100 (FIG. 1). As illustrated, the receiver 304 may control 306 the live VOD/eMBMS raw video stream captured by the server 302. The receiver may also send environmental data 308A to the server 302.

At the server 302, a live VOD/eMBMS raw video stream is captured at block 312. Chromatic color compensation is applied to the raw image stream at block 314. In particular a correction faction is applied to the image stream as indicated at block 308B. The correction factor may be based on the environmental information captured by the receiver. In embodiments, the color compensation is performed as is described with respect to FIG. 2. At block 316, the color compensated data stream is encoded and packetized for transmission. The streaming data is transmitted at reference number 310. At the receiver 304, the streaming data is depacketized and decoded as indicated at reference number 318. The compensated streaming data is rendered at block 320. In this manner, the chromatic processing chain is applied to live image streams. A device specific chromatic color compensated streaming video is generated. This produces quality live event streaming videos, or eMBMS streaming.

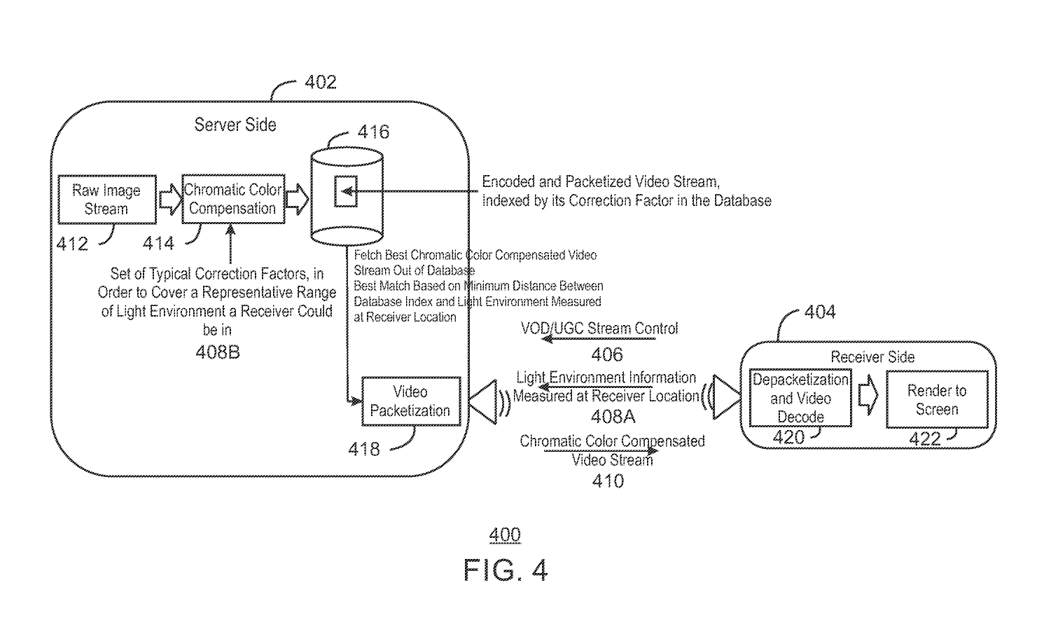

FIG. 4 is an illustration of a system 400 that enables remote adaptation of pre-recorded streaming data based on the environment at a receiver. A server 402 may be a component of a content provider 134 (FIG. 1). A receiver 402 may be an electronic device 100 (FIG. 1). As illustrated, the receiver 404 may control 406 the VOD/UGC video stream at block captured and/or stored by the server 402. The receiver may also send environmental data 408A to the server 402.

At the server 402, a VOD/UGC raw image stream is captured and/or stored at block 412. Chromatic color compensation is applied to the raw image stream at block 414. A set of typical correction factors is applied to the image stream as indicated at block 408B. The correction factor is typical in that it is configured to apply to a representative range of the lighting environments that the receiver may be located. In embodiments, the color compensation is performed as is described with respect to FIG. 2. At block 416, the color compensated data stream is encoded and packetized for transmission and is indexed by its correction factor in a database. Thus, each video may be saved in the database in multiple versions with a plurality of correction factors applied. The video selected for transmission may be the best chromatic color compensated video stream in the database that matches the light environment at the receiver location. In particular, the best match is described as the one with a minimum distance between the database index and the light environment at the receiver location. Put another way, the best match may be the video with a correction factor that most closely matches the expected light environment at the receiver location. The selected video is packetized at block 418. The streaming data is transmitted at reference number 410. At the receiver 404, the streaming data is depacketized and decoded as indicated at reference number 420. The compensated streaming data is rendered at block 422. In this manner, the chromatic processing chain is offline, and the device specific light environment information is used to control the pre-encoded video to be streamed to the receiver.

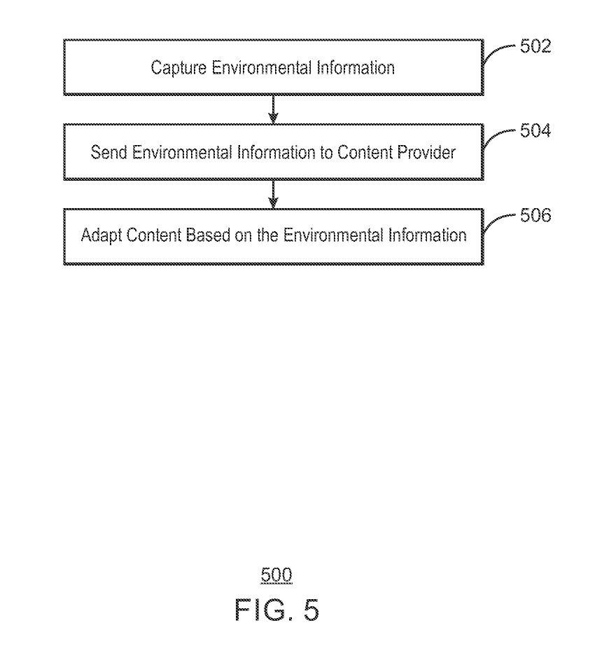

FIG. 5 is a process flow diagram of a method 500 for remote adaptation of streaming data based on the environment at a receiver. The present techniques addresses the remote chromatic color compensation of streaming video content based on environmental light color temperature at the location the video is going to be rendered/consumed. As used herein, the receiver is the end-user device where video is going to be rendered. Additionally, as used herein, the server is a typical cloud based service where video is sent to the receiver. At block 502, the environmental information is captured. In embodiments, the environmental information is captured on a periodic basis at a mobile device/mobile receiver. The environmental information may include the environmental light (or color temperature) at the location the streaming video is going to be rendered. Additionally, in embodiments, the environmental information may be captured using a plurality of sensors, such as a camera sensor or by a RGB sensor. The RGB sensor is to provide the environmental light level for each RGB component. In embodiments, using a RGB sensor has a significant advantage over camera sensing, as it is also very low-power consuming (and is a low-cost hardware component).

At block 504, the environmental information is sent to the content provider. In embodiments, the environmental information is sent to the content provider on a periodic basis. The environmental information may be sent to the network hosted server or the remote streaming video provider (VOD/UGC provider) using whatever IP connection is available (for example, WLAN, or cellular). At block 506, the content is adapted based on the environmental information. In particular, upon reception of environment information captured at device level, or upon reception of environment information captured at device level that shows significant degradation when compared to a previously received and stored message, the network hosted server will take the decision to adapt the chromatic content of its streaming video to be sent. In this manner, the transmitted content is suitable for the lighting environment at receiver location. For example, chromatic color content may be made to look more yellow (R+G) when receiver light environment is blue-ish (B), as is the case under some LED lighting. Since the content has been adapted for the environmental conditions, a power savings at the mobile device can occur since there is not additional processing performed at the mobile device. Moreover, adaptation can be done either on-the-fly, or based on library or pre-compensated video segments.

Adaptation of the video may occur at a network or cloud hosted server as described above. In embodiments, the video may also be adapted at the device according to the techniques described herein. In such a scenario, the environmental information is captured by the device, and applied to a streaming data received at the device. The device may include a buffer to store streaming data prior to adaptation at the device. In embodiments, the buffer at the device in a first in, first out buffer. Additionally, in embodiments, a cloud streaming server receives both the video streaming request and the environment information and uses this information to either encode video content adapted for the receiver on the fly, or fetches an appropriate chromatic color compensated video (or video segment) out of a repository, and then sends the video to the receiver using typical streaming protocols, such as Real-time Transport Protocol (RTP) over IP.

Thus, the present techniques use end-user reported information to control chromatic color adaptation of streaming video in order to optimize overall end user experience. In examples, the color content is adapted so a streaming video does not look ‘washed out’ when video playback is rendered on a device in a blue-ish light environment which is typical of some LED lighting. In such an example, the aim may be to boost Red and Green content over Blue to implement the compensation described herein. In another example, the color content is adapted so a streaming video does not look ‘washed out’ when video playback is rendered on a device in a red-ish light environment, which is typical of a sunset environment. In this example, the aim may be to boost Blue and Green content over Red content to implement the compensation described herein.

In a use case of advertisers or third party content providers, ensuring that the rendered video is optimally viewable in any environment enables a higher number of views among a group of electronic device users. In embodiments, cloud served video is compensated before it is streamed to the receiver, using light environment information captured at receiver location. In embodiments, the chromatic color compensation can be done on-the-fly for live video content (for example, a live retransmission of sport event over VOD or eMBMS) or offline for UGC content or movie VOD.

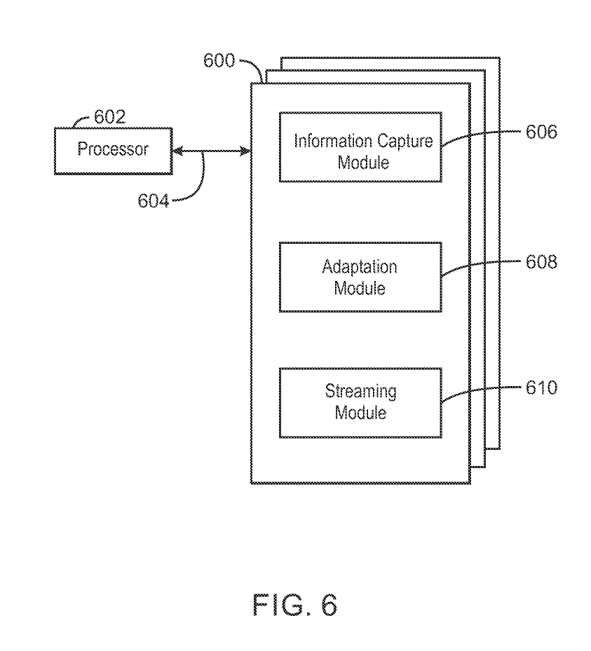

FIG. 6 is a block diagram showing media 600 that contains logic for user input based environmental condition capture. The media 600 may be a computer-readable medium, including a non-transitory medium that stores code that can be accessed by a processor 602 over a computer bus 604. For example, the computer-readable media 600 can be volatile or non-volatile data storage device. The media 600 can also be a logic unit, such as an Application Specific Integrated Circuit (ASIC), a Field Programmable Gate Array (FPGA), or an arrangement of logic gates implemented in one or more integrated circuits, for example.

The media 600 may include modules 606-610 configured to perform the techniques described herein. For example, an information capture module 606 may be configured to capture environmental conditions at an electronic device. The information capture module may also be used to configure a look up table that includes a color compensation matrix. In embodiments, an end user sends a request for video streaming delivery to a video streaming server (VOD/UGC/eMBMS). In embodiments, the streaming server is a cloud-based server. A request for video streaming may be sent using transmission protocols such as Hypertext Transfer Protocol (HTTP) over Internet Protocol (IP). This request may result in the capture of environmental information. Accordingly, in embodiments, an end user device may send, information about the light environment where receiver is located on a periodic basis. The information about the light environment where receiver is located is typically also sent using HTTP over IP, and can be captured either by a camera sensor or by a simple RGB sensor (providing the environmental light level for each RGB component). In embodiments, using an RGB sensor has a significant advantage when compared to camera sensing, as it is also very low-power consuming and is a low-cost hardware component.

An adaptation module 608 may be configured to apply the environmental information to streaming data. In embodiments, a cloud streaming server receives both the video streaming request and the light environment information and uses this information to either encode video content adapted for the receiver on the fly, or fetches an appropriate chromatic color compensated video (or video segment) out of a repository, and then sends the video to the receiver using typical streaming protocols, such as Real-time Transport Protocol (RTP) over IP.

A streaming module 610 may be configured stream the adapted data. In embodiments, on a periodic basis, the cloud streaming server receives new light environment measures done at receiver location, and either adjusts its encoding parameters, or sends more appropriate video (or video segment) to the receiver. In some embodiments, the modules 606-610 may be modules of computer code configured to direct the operations of the processor 602.

The block diagram of FIG. 6 is not intended to indicate that the media 600 is to include all of the components shown in FIG. 6. Further, the media 600 may include any number of additional components not shown in FIG. 6, depending on the details of the specific implementation.

By hosting the chromatic video processing in the cloud or on the server side rather than on the device, several operator/video service provider benefits may be enabled. First, the technology reach may be increased because it does not require dedicated processing power/HW accelerator at device level. Additionally, chromatic color compensation can be done locally on the rendering device is the device includes the hardware or software used for color compensation. Color compensation by a content provider can allocate enough CPU processing power to run the processing in software.

In embodiments, local chromatic color compensation may be dependent on the end device being powerful enough, or the end device encompassing the right hardware. Running the chromatic compensation in the cloud/on a server means the solution can be deployed to a broader base of devices, even those who do neither have enough CPU horsepower nor the dedicated hardware acceleration to run the chromatic compensation locally.

Moreover, the present techniques increases the technology reach because the bandwidth required for server to device streaming is decreased. In embodiments, the RGB information about ambient light at the device level, sensed by the RGB sensor local to the device and periodically uploaded to the server, can be used by the server to pre-process video prior to the transmission, so only chromatic content that is visible by an end-user eye under the current ambient light gets sent to the device. The color chromatic processing done on the server can yield more optimized video streams as a result of a more efficient bit allocation during the encoding process. Moreover, color chromatic processing can yield streams encoded at a lower bitrate. Additionally, as limited chromatic video content is visible by the end user eye, there is no need to encode all chromatic content of source video at the same quality level; server-hosted video encoder can allocate less bits to encode chromatic content that is hardly visible by the end-user, and thus server-hosted encoder can yield smaller encoded video files or smaller encoded video segment when compared to video streams encoded without chromatic pre-processing.

Example 1 is an apparatus. The apparatus includes an environmental conditions capture mechanism to obtain environmental information from a receiver; a controller to control streaming data based on the environmental information, wherein the receiver is to receive streaming data that is adapted based on the environmental information and a volume of the streaming data is reduced as a result of adapting the streaming data.

Example 2 includes the apparatus of example 1, including or excluding optional features. In this example, the environmental information is ambient lighting information.

Example 3 includes the apparatus of any one of examples 1 to 2, including or excluding optional features. In this example, the environmental conditions capture mechanism is a plurality of sensors.

Example 4 includes the apparatus of any one of examples 1 to 3, including or excluding optional features. In this example, the environmental conditions capture mechanism is a camera, an RGB sensor, or any combination thereof.

Example 5 includes the apparatus of any one of examples 1 to 4, including or excluding optional features. In this example, control of the streaming data comprises manipulating the data based on environmental conditions.

Example 6 includes the apparatus of any one of examples 1 to 5, including or excluding optional features. In this example, reducing the volume of the streaming data is a result of sending only a relevant chromatic content to the receiver.

Example 7 includes the apparatus of any one of examples 1 to 6, including or excluding optional features. In this example, adapting the streaming data comprises compensating colors of the streaming data based on the environmental conditions.

Example 8 includes the apparatus of any one of examples 1 to 7, including or excluding optional features. In this example, adapting the streaming data comprises applying a color compensation matrix to streaming data in a pixel buffer.

Example 9 includes the apparatus of any one of examples 1 to 8, including or excluding optional features. In this example, the adapted streaming data is stored in a repository for later transmission to the receiver.

Example 10 includes the apparatus of any one of examples 1 to 9, including or excluding optional features. In this example, the streaming data is captured on the fly.

Example 11 includes the apparatus of any one of examples 1 to 10, including or excluding optional features. In this example, the streaming data is obtained from a data repository.

Example 12 includes the apparatus of any one of examples 1 to 11, including or excluding optional features. In this example, environmental information is ambient noise.

Example 13 includes the apparatus of any one of examples 1 to 12, including or excluding optional features. In this example, adapting the streaming data comprises compensating audio volume the streaming data based on the environmental information.

Example 14 is a method. The method includes obtaining environmental information from a receiver; obtaining streaming data; modifying the streaming data based on the environmental information; and transmitting the modified streaming data to the receiver, wherein a volume of the streaming data is reduced as a result of modifying the streaming data.

Example 15 includes the method of example 14, including or excluding optional features. In this example, the environmental information is ambient lighting information.

Example 16 includes the method of any one of examples 14 to 15, including or excluding optional features. In this example, the environmental information is obtained via a plurality of sensors.

Example 17 includes the method of any one of examples 14 to 16, including or excluding optional features. In this example, the environmental information is obtained via a camera, an RGB sensor, or any combination thereof.

Example 18 includes the method of any one of examples 14 to 17, including or excluding optional features. In this example, the streaming data is captured at a content provider.

Example 19 includes the method of any one of examples 14 to 18, including or excluding optional features. In this example, reducing the volume of the streaming data is a result of sending only a relevant chromatic content to the receiver.

Example 20 includes the method of any one of examples 14 to 19, including or excluding optional features. In this example, modifying the streaming data comprises compensating colors of the streaming data based on the environmental conditions.

Example 21 includes the method of any one of examples 14 to 20, including or excluding optional features. In this example, modifying the streaming data comprises applying a color compensation matrix to streaming data in a pixel buffer.

Example 22 includes the method of any one of examples 14 to 21, including or excluding optional features. In this example, the modified streaming data is stored in a repository for subsequent transmission to a receiver.

Example 23 includes the method of any one of examples 14 to 22, including or excluding optional features. In this example, the streaming data is captured on the fly, modified and transmitted to the receiver on the fly.

Example 24 is a system. The system includes a display; a radio; a memory that is to store instructions and that is communicatively coupled to the display; and a processor communicatively coupled to the radio and the memory, wherein when the processor is to execute the instructions, the processor is to: capturing environmental information; transmitting the environmental information to a content provider; obtaining receiving streaming data modified based on the environmental information from the content provider, wherein a volume of the streaming data is reduced as a result of modifying the streaming data; and rendering the modified streaming data at the receiver.

Example 25 includes the system of example 24, including or excluding optional features. In this example, the reduced volume of the streaming data is a result of sending only a relevant chromatic content to the receiver.

Example 26 includes the system of any one of examples 24 to 25, including or excluding optional features. In this example, the environmental information is ambient lighting information.

Example 27 includes the system of any one of examples 24 to 26, including or excluding optional features. In this example, the environmental conditions are captured via a plurality of sensors.

Example 28 includes the system of any one of examples 24 to 27, including or excluding optional features. In this example, the environmental conditions are captured via is a camera, an RGB sensor, or any combination thereof.

Example 29 includes the system of any one of examples 24 to 28, including or excluding optional features. In this example, modified streaming data is modified by manipulating the streaming data based on environmental conditions.

Example 30 includes the system of any one of examples 24 to 29, including or excluding optional features. In this example, modified streaming data is modified by compensating colors of the streaming data based on the environmental conditions.

Example 31 includes the system of any one of examples 24 to 30, including or excluding optional features. In this example, modified streaming data is modified by applying a color compensation matrix to streaming data in a pixel buffer.

Example 32 includes the system of any one of examples 24 to 31, including or excluding optional features. In this example, the modified streaming data is stored in a repository for later transmission to the receiver.

Example 33 includes the system of any one of examples 24 to 32, including or excluding optional features. In this example, the streaming data is captured on the fly.

Example 34 includes the system of any one of examples 24 to 33, including or excluding optional features. In this example, the streaming data is obtained from a data repository.

Example 35 includes the system of any one of examples 24 to 34, including or excluding optional features. In this example, environmental information is ambient noise.

Example 36 includes the system of any one of examples 24 to 35, including or excluding optional features. In this example, adapting the streaming data comprises compensating audio volume the streaming data based on the environmental information.

Example 37 is a computer-readable medium. The computer-readable medium includes instructions that direct the processor to obtain environmental information from a receiver; obtain streaming data; modify the streaming data based on the environmental information; and transmit the modified streaming data to the receiver, wherein a volume of the streaming data is reduced as a result of modifying the streaming data.

Example 38 includes the computer-readable medium of example 37, including or excluding optional features. In this example, the environmental information is ambient lighting information.

Example 39 includes the computer-readable medium of any one of examples 37 to 38, including or excluding optional features. In this example, the environmental information is obtained via a plurality of sensors.

Example 40 includes the computer-readable medium of any one of examples 37 to 39, including or excluding optional features. In this example, the environmental information is obtained via a camera, an RGB sensor, or any combination thereof.

Example 41 includes the computer-readable medium of any one of examples 37 to 40, including or excluding optional features. In this example, the streaming data is obtained captured at a content provider.

Example 42 includes the computer-readable medium of any one of examples 37 to 41, including or excluding optional features. In this example, reducing the volume of the streaming data is a result of sending only a relevant chromatic content to the receiver.

Example 43 includes the computer-readable medium of any one of examples 37 to 42, including or excluding optional features. In this example, modifying the streaming data comprises compensating colors of the streaming data based on the environmental conditions.

Example 44 includes the computer-readable medium of any one of examples 37 to 43, including or excluding optional features. In this example, modifying the streaming data comprises applying a color compensation matrix to streaming data in a pixel buffer.

Example 45 includes the computer-readable medium of any one of examples 37 to 44, including or excluding optional features. In this example, the modified streaming data is stored in a repository for subsequent transmission to a receiver.

Example 46 includes the computer-readable medium of any one of examples 37 to 45, including or excluding optional features. In this example, the streaming data is captured on the fly, modified and transmitted to the receiver on the fly.

Example 47 is an apparatus. The apparatus includes instructions that direct the processor to an environmental conditions capture mechanism to obtain environmental information from a receiver; a means to control streaming data based on the environmental information to the receiver, wherein the receiver is to receive streaming data that is adapted based on the environmental information, and a volume of the streaming data is reduced as a result of adapting the streaming data.

Example 48 includes the apparatus of example 47, including or excluding optional features. In this example, the environmental information is ambient lighting information.

Example 49 includes the apparatus of any one of examples 47 to 48, including or excluding optional features. In this example, the environmental conditions capture mechanism is a plurality of sensors.

Example 50 includes the apparatus of any one of examples 47 to 49, including or excluding optional features. In this example, the environmental conditions capture mechanism is a camera, an RGB sensor, or any combination thereof.

Example 51 includes the apparatus of any one of examples 47 to 50, including or excluding optional features. In this example, the means to control the streaming data manipulates the data based on environmental conditions.

Example 52 includes the apparatus of any one of examples 47 to 51, including or excluding optional features. In this example, reducing the volume of the streaming data is a result of sending only a relevant chromatic content to the receiver.

Example 53 includes the apparatus of any one of examples 47 to 52, including or excluding optional features. In this example, adapting the streaming data comprises compensating colors of the streaming data based on the environmental conditions.

Example 54 includes the apparatus of any one of examples 47 to 53, including or excluding optional features. In this example, adapting the streaming data comprises applying a color compensation matrix to streaming data in a pixel buffer.

Example 55 includes the apparatus of any one of examples 47 to 54, including or excluding optional features. In this example, the adapted streaming data is stored in a repository for later transmission to the receiver.

Example 56 includes the apparatus of any one of examples 47 to 55, including or excluding optional features. In this example, the streaming data is captured on the fly.

Example 57 includes the apparatus of any one of examples 47 to 56, including or excluding optional features. In this example, the streaming data is obtained from a data repository.

Example 58 includes the apparatus of any one of examples 47 to 57, including or excluding optional features. In this example, environmental information is ambient noise.

Example 59 includes the apparatus of any one of examples 47 to 58, including or excluding optional features. In this example, adapting the streaming data comprises compensating audio volume the streaming data based on the environmental information.

It is to be understood that specifics in the aforementioned examples may be used anywhere in one or more embodiments. For instance, all optional features of the computing device described above may also be implemented with respect to either of the methods or the computer-readable medium described herein. Furthermore, although flow diagrams and/or state diagrams may have been used herein to describe embodiments, the techniques are not limited to those diagrams or to corresponding descriptions herein. For example, flow need not move through each illustrated box or state or in exactly the same order as illustrated and described herein.

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the present techniques.

What is claimed is:

1. An apparatus, comprising:
an environmental conditions capture mechanism to obtain environmental information from a receiver;
a controller to control streaming data based on the environmental information, wherein the receiver is to receive streaming data that is adapted based on the environmental information and a volume of the streaming data is reduced as a result of adapting the streaming data.

2. The apparatus of claim 1, wherein the environmental information is ambient lighting information.

3. The apparatus of claim 1, wherein the environmental conditions capture mechanism is a plurality of sensors.

4. The apparatus of claim 1, wherein the environmental conditions capture mechanism is a camera, an RGB sensor, or any combination thereof.

5. The apparatus of claim 1, wherein control of the streaming data comprises manipulating the data based on environmental conditions.

6. The apparatus of claim 1, wherein reducing the volume of the streaming data is a result of sending only a relevant chromatic content to the receiver.

7. The apparatus of claim 1, wherein adapting the streaming data comprises applying a color compensation matrix to streaming data in a pixel buffer.

8. The apparatus of claim 1, wherein the adapted streaming data is stored in a repository for later transmission to the receiver.

9. The apparatus of claim 1, wherein the streaming data is captured on the fly.

10. The apparatus of claim 1, wherein the streaming data is obtained from a data repository.

11. The apparatus of claim 1, wherein environmental information is ambient noise.

12. The apparatus of claim 1, wherein adapting the streaming data comprises compensating audio volume the streaming data based on the environmental information.

13. A method, comprising:
obtaining environmental information from a receiver;
obtaining streaming data;
modifying the streaming data based on the environmental information; and
transmitting the modified streaming data to the receiver, wherein a volume of the streaming data is reduced as a result of modifying the streaming data.

14. The method of claim 13, wherein the environmental information is ambient lighting information.

15. The method of claim 13, wherein the environmental information is obtained via a plurality of sensors.

16. The method of claim 13, wherein the environmental information is obtained via a camera, an RGB sensor, or any combination thereof.

17. The method of claim 13, wherein the streaming data is obtained captured at a content provider.

18. The method of claim 13, wherein modifying the streaming data comprises compensating colors of the streaming data based on the environmental conditions.

19. A system, comprising:
a display;
a radio;
a memory that is to store instructions and that is communicatively coupled to the display; and
a processor communicatively coupled to the radio and the memory, wherein when the processor is to execute the instructions, the processor is to:
capturing environmental information;
transmitting the environmental information to a content provider;
obtaining receiving streaming data modified based on the environmental information from the content provider, wherein a volume of the streaming data is reduced as a result of modifying the streaming data; and
rendering the modified streaming data at the receiver.

20. The system of claim 19, wherein the environmental information is ambient lighting information.

21. The system of claim 19, wherein the environmental conditions are captured via a plurality of sensors.

22. The system of claim 19, wherein the environmental conditions are captured via is a camera, an RGB sensor, or any combination thereof.

23. The system of claim 19, wherein the reduced volume of the streaming data is a result of sending only a relevant chromatic content to the receiver.

24. A computer-readable medium, comprising instructions that, when executed by the processor, direct the processor to:
obtain environmental information from a receiver;
obtain streaming data;
modify the streaming data based on the environmental information; and
transmit the modified streaming data to the receiver, wherein a volume of the streaming data is reduced as a result of modifying the streaming data.

25. The computer-readable medium of claim 24, wherein the environmental information is ambient lighting information.
